(19) United States
(12) Patent Application Publication
(10) Pub. No.: US 2011/0210550 A1
(43) Pub. Date: Sep. 1, 2011

(54) POWER GENERATION UNIT AND A METHOD GENERATING ELECTRIC ENERGY

(76) Inventors: Mats Leijon, Uppsala (SE); Hans Bernhoff, Uppsala (SE)

(21) Appl. No.: 12/998,264

(22) PCT Filed: Oct. 3, 2008
(86) PCT No.: PCT/SE2008/051122

§ 371 Date: May 12, 2011

(51) Int. Cl. H02P 9/04

(52) U.S. Cl. 290/44

(57) ABSTRACT

The invention relates to a power generation unit. The unit has a turbine (3), a generator (8) and an electric connection means (9-12) connecting the generator (6) to an electric network (2). According to the invention the generator (8) is a permanent magnet synchronous generator, which has a low load angle. The electric connection means includes a diode rectifier (9) for supplying DC-voltage. The invention also relates to a use of the invented power generation unit and to a method for generating electric energy.

### FIELD OF INVENTION

The present invention in a first aspect relates to a power generation unit including a turbine, a generator driven by the turbine, an electric connection means for connecting the generator to an electric network, and turbine speed control means.

In a second aspect the invention relates to a use of such a power generation unit.

In a third aspect the invention relates to a method for generating electric energy in which a turbine is exposed to a flowing fluid, the turbine drives a generator and the generator is connected to an electric network, and turbine speed control means.

### BACKGROUND OF THE INVENTION

In most kinds of aggregates for generating electric energy the turbine is driven by a fast flowing fluid, e.g. water in a conventional hydropower plant or steam. The generator thereby is driven at substantially constant speed and the energy generated matches the network to which it is supplied.

The continuously increasing demand for electric energy has during the recent decades led to efforts to commercially make use of alternative sources for generating electric energy such as slow water currents and the wind. The velocity of the flow for these sources is normally much lower and is fluctuating. In particular the wind velocity can vary considerably.

A turbine driven by a water current or by the wind thus typically rotates at comparatively low rpm. Furthermore the rotational speed of the turbine will vary. This creates problem when supplying the energy to a network since the generated energy only for a certain rpm will match the network, but at other speeds there will be a miss-match.

This problem can be solved by mechanically breaking the rotation of the turbine or by adjusting the turbine blades in order to maintain a substantially constant rpm. Such measures for controlling the speed of the turbine however are costly. In addition such mechanical measures are sources for failures.

The object of the present invention therefore is to control the turbine in a way that is more simple and reliable.

### SUMMARY OF THE INVENTION

The object of the invention is achieved in that a power generation unit as initially specified includes the specific features that the generator is a permanent magnet synchronous generator with a low load angle and in that the electric connection means includes a diode rectifier for supplying a DC voltage whereby the rotational speed of the turbine is controlled by the DC-voltage-level.

When the generator is connected to a strong network via a DC-link as specified in the claim the network can be used to control the rpm of the turbine. In case of a tendency of the rpm to change it means that the electrical and mechanical energy do not harmonize with each other and there will be an oscillation towards a new operating point to adapt to the new condition. With the electrical connection according to the claim and with a low loading angle the generator will function as a brake in case the turbine tends to increase its rpm and reduce energy outtake if the turbine tends to decrease its energy. This eliminates the need for external equipment to maintain matching between the mechanical energy from the turbine and the electrical energy supplied to the network. A power generation unit according to the invention will therefore be particularly suitable for applications where the turbine is exposed to a driving fluid of varying velocity, and with a strong network the operation point will be at substantially maintained rpm of the turbine.

According to a preferred embodiment the electrical control means includes means for regulating the DC-level.

Since the rotational speed of the turbine is directly related to the DC-level this embedment allows adjustment of this speed in an easy way, eliminating any need for mechanical adjustment.

According to a further preferred embodiment the means for regulating the DC-level includes an inverter 11 with inverter-control means 27 and/or a transformer 12 with ratio-control means.

Thereby a simple and reliable way of regulating the DC-level is provided by components that normally will be present in the electric control means.

According to a further preferred embodiment the generator includes means for changing the number of active winding turns in the generator.

Since the voltage is determined by

$$U = N \frac{d ϕ}{d t} ,$$

the number of turns directly effects the voltage level. Changing the number of active turns in the generator thus offers a secure and precise control of the rotational speed governed by the DC-level. This arrangement eliminates the need to apply a variable transformer or inverter-control for regulating the rotational speed of the turbine. Thereby the to electric control means becomes more simple and less sensitive to disturbances. In some applications the generator-based control can be a complement to controlling the inverter or transformer in this respect. Preferably the means for changing the number of active windings turns in the generator includes a tap changer.

According to a further preferred embodiment of the invention the turbine is a wind turbine.

A wind turbine is a very important example where the velocity of the fluid driving the turbine fluctuates. The invented unit for controlling the rpm of the turbine therefore is of particular interest for this kind of applications.

According to a further preferred embodiment, the wind turbine has a vertical axis.

A vertical axis wind turbine has many advantages over those of the horizontal axis type. The need to control the rpm of the turbine is also comparatively accentuated for a vertical axis turbine. To mechanically control the rpm is more complicated for this type of turbine and the invention therefore is particularly important for such applications.

According to a further preferred embodiment the turbine is arranged to be powered by sea waves or a water current.

A turbine operated by sea waves and slow water current is rotating relatively slow and is exposed to changes in the water velocity. Therefore the advantages of the present invention are of particular interest for such applications.

According to a further preferred embodiment the load angle is smaller than 12°.

Although the invention functions satisfactory also at somewhat higher load angles such as up to 15° or 20°, the control according to the invention becomes optimized if arranging the load angle to be lower than 12°. Best results are achieved if the load angle is below 10°.

According to a further preferred embodiment the electrical connection means is arranged to supply a voltage of at least 10 kV.

This voltage level represents that the unit is connected to a strong network. The stronger the network is the more effectively the rpm-control according to the invention will be.

According to a further preferred embodiment the electrical connection means includes a capacitor connected to ground.

This connection will have a dampening effect on the oscillations occurring when the generator responses to a tendency towards change of rpm such that the transient period to reach back to the normal rpm is shortened. This makes the is control system still more effective.

According to a further preferred embodiment the stator winding of the generator includes a cable.

According to a further preferred embodiment the cable includes a central core of conducting material surrounded by an insulation system including an inner and an outer semi-conducting layer and an intermediate layer of solid insulating material.

A cable of this kind has the advantage that it can endure a very high voltage to be induced.

According to a further preferred embodiment the electrical connecting means includes a supervising system for measuring, controlling and/or governing the operation of the power generation unit.

Such a system provides a possibility to adapt and adjust the characteristics of the power generation unit to the actual conditions and thereby optimize its operation.

According to a preferred embodiment the supervising system includes means for measuring the current, the voltage and/or the load angle.

These are all very important parameters relating to the operation of the power generator unit, and a continuous update of the value of these contribute to obtain an operation that complies with the prevailing conditions.

According to a further preferred embodiment the supervising system includes means for synchronizing the voltage of the power generation unit the voltage of the electrical network.

The synchronization increases the precision of the rotational speed control.

According to a further preferred embodiment the supervising system includes a protection relay.

Thereby the safety of the power generation unit is increased and the risk that fault conditions harm its components is reduced.

According to a further preferred embodiment, the supervising system includes means for controlling the active and reactive power.

The relation between the active and reactive power is important for obtaining a high efficiency in converting and distributing the induced energy.

According to a further preferred embodiment the supervising system includes means for measuring the amount of delivered energy.

Such means allows a direct billing system to be connected to the power generation unit.

According to further preferred embodiments the supervising system includes various further means for specific functions, such as
means for electrically braking the turbine,
means for electrically locking the turbine and
means for controlling starting-up of the turbine, respectively.

Thereby further advantages relating to the electric speed control are gained since these functions can be performed more effectively and with less energy losses than would be the case of these functions had to be carried out mechanically.

According to a further preferred embodiment the supervising system includes a micro-processor having means for receiving input signals representing data from the supervising system, means for processing the received signals and means for providing output signals representing operation commands to the supervising system.

Such a computerization of the supervising system will further increase the reliability, the preciseness and the efficiency of thereof.

According to various further preferred embodiments the electrical connection means includes the various preferred types of components such as
a wye-delta-transformer,
controllable power semiconductor elements such as IGBT:s, GTO:s and/or tyristors, and
a 6-pulse or a 12-pulse inverter, respectively.

Components being of the above mentioned type are particularly suitable when applied for a power generation unit according to the invention and thereby contribute to optimize the system as a whole.

According to a further aspect of the invention, a power plant includes a plurality of power generation units according to the present invention, in particular to any of the preferred embodiments thereof, which power generation units are connected to the same DC-level.

Such a plant gains the corresponding advantages as the invented power generation unit as disclosed above. By connecting the power generation units to the same DC-level a uniform and stable operation of the plant is obtained.

The object of the invention is further achieved by a use of the invented power generation unit for generating electric energy and supplying the energy to an electric network.

Finally the object of the invention is also achieved in that a method as initially specified includes the specific measures of providing the generator with permanent magnets, operating the generator as a synchronous generator and at a low load angle, providing a diode rectifier for supplying DC-voltage and thereby controlling the rotational speed of the turbine to be substantially constant at short time scales.

According to preferred embodiments of the invented method it is performed by using a power generation unit according to the present invention, in particular according to any of the preferred embodiments thereof.

The invented use and the invented method have advantages of similar kind as those of the invented power generation unit, and the preferred embodiments thereof, which advantages have been described above.

The invention will be further explained by the following detailed description of an example of a power generation unit according to the invention with reference to the accompanying drawing.

### BRIEF DESCRIPTION OF THE DRAWING

FIG. 1 is a schematical illustration of a first example of the invented power generating unit.

FIG. 2 is an illustration corresponding to that of FIG. 1 but showing a second example.

FIG. 3 is a block diagram illustrating the control of a power generation unit according to the examples in FIG. 1 or 2.

FIG. 4 is a block diagram illustrating a plant according to the invention.

FIG. 5 is a cross section through a cable in the stator winding of the generator according to an example of the invention.

### DESCRIPTION OF AN EXAMPLE OF THE INVENTION

FIG. 1 schematically illustrates a wind power assembly 1 connected to a network 2. The wind power assembly has a vertical axis wind turbine 4 which is connected by a vertical shaft 4a to the rotor 5 of a generator 6. The turbine has a number of vertical blades 7, each blade 7 being connected to the shaft by a pair of arms 8. Typically the number of blades is three. The turbine is exposed to the wind having a velocity v.

The generator 6 is a synchronous generator and its rotor 5 is provided with permanent magnets. The voltage from the generator is supplied to a diode rectifier 9 such as to obtain DC. The DC-link is connected to ground via a capacitor 10. Thereafter an inverter supplies the voltage to the network through a transformer 12 with an output of e.g. 10 kV.

If the velocity v of the wind changes it affects the rpm of the turbine to be changed correspondingly. With the illustrated connection of the generator 5 to the network 2 and with a load angle about 10° this change of rpm is electrically counteracted by the generator 6. If the wind increases, the generator 6 will provide a retarding torque on the turbine shaft 4. If the wind decreases, the generator will provide an accelerating torque on the turbine shaft, with the result that the rpm after a short transient period will maintain its normal value.

The transformer 12 is of the delta-wye-type and has ratio-control. The inverter 11 is provided with an inverter-control 27. By means of the ratio-control of the transformer 12 or by the inverter-control 27 a fixed DC-level can be set.

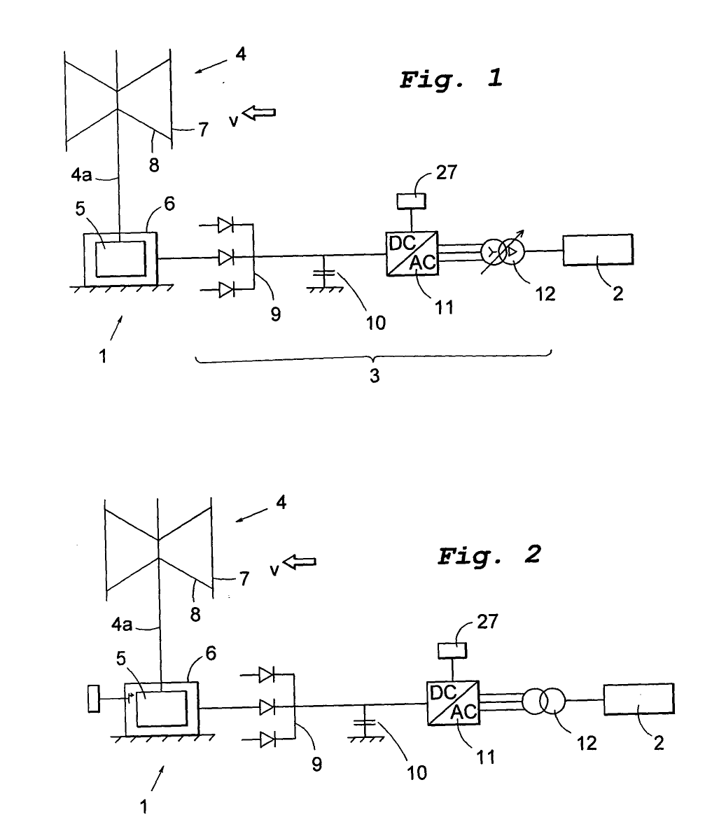

FIG. 2 illustrates an alternative example of a power generation unit according to the invention. In this example the generator 6 is provided with a tap changer 13 such that the number of active turns in the stator windings can be selected. By selecting an appropriate number of winding turns the DC-level can be pre-set to the required level. In this example the transformer 12 therefore can be a fixed transformer.

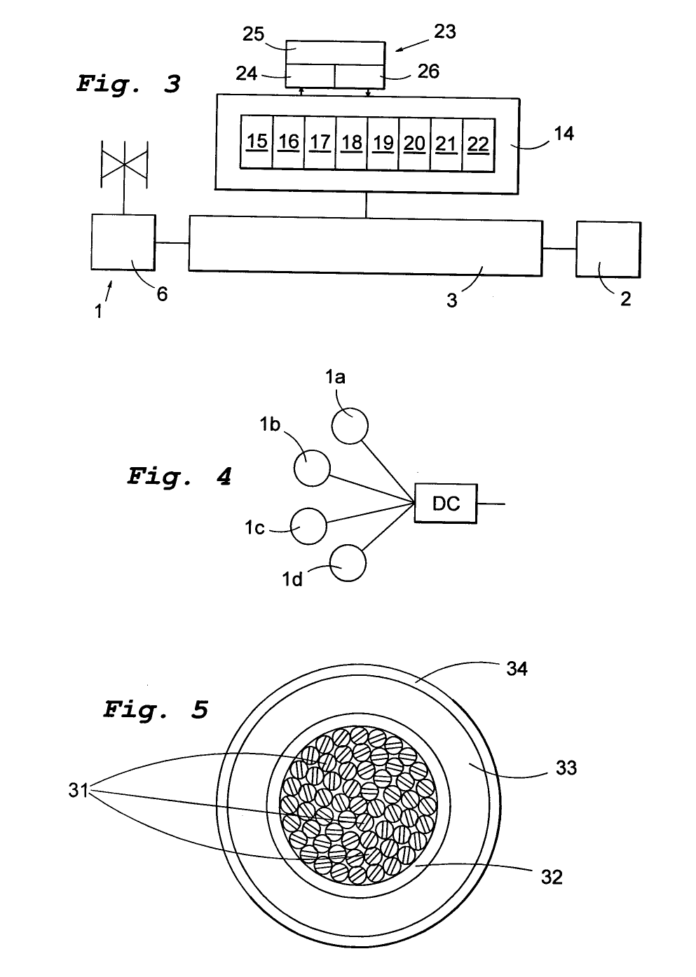

FIG. 3 in a block diagram represents the example of FIG. 1 or FIG. 2 and illustrates a supervising system 14 for measuring, controlling and governing the operation of a power generation unit as illustrated in FIG. 1 or 2.

The supervising system 14 is provided with measuring means 15 for measuring the current, the voltage and the load angle, synchronizing means 16 for synchronizing the voltage of the power generation unit to the voltage of the electrical network 2, a protecting relay 17, means 18 for controlling the active and reactive power, means 19 for measuring the amount of delivered energy, means 20 for electrically braking the turbine, means 21 for electrically locking the turbine and means 22 for controlling starting-up of the turbine.

The supervising system is provided with a micro-processor 23. The micro-processor 23 has means 24 for receiving input signals from the supervising-system 14. These signals represent data obtained by the supervising system and are processed in a processing unit 25. The micro-processor also has means 26 for providing output signals to the supervising system 14 with operation commands as a result of the processed information.

FIG. 4 is a block diagram representing a power generation plant having four power generation units (1a-1d). They are all connected in a way described above to a common DC-level.

FIG. 5 shows a cross section through a high-voltage cable that may be advantageous to use for the stator winding in certain applications of the invention. The cable consists of a core with one or more strand parts 31 of copper. The core is surrounded by an inner semiconducting layer 32. Outside this is a layer of solid insulation 33, e.g. PEX insulation. Around the insulation is an outer semiconducting layer 34. Each of the semiconducting layers forms an equipotential surface.

1-29. (canceled)

30. A power generation unit including a turbine (3), a generator (6) driven by the turbine (3), an electric connection means (9-12) for connecting the generator (6) to an electrical network (2) and to turbine speed control means, wherein the turbine is exposed to a driving fluid of varying velocity, wherein the turbine speed control means is variable for substantially maintaining the turbine rpm and comprises electrical control means, wherein the generator (6) is a permanent magnet synchronous generator operating at a low load angle which is smaller than 12°, wherein the electrical connection means (9-12) includes a diode rectifier (9) for supplying a DC voltage and means (11, 12, 13) for regulating the DC-voltage-level, whereby the rotational speed of the turbine is controlled by the DC-voltage-level, and wherein the means for regulating the network DC-voltage-level includes an inverter with inverter-control means (27), a transformer (12) with ratio-control means and/or means (13) for changing the number of active windings turns in the generator.

31. The power generation unit according to claim 30, wherein the turbine (3) is a wind turbine.

32. The power generation unit according to claim 31, wherein the wind turbine (3) has a vertical axis.

33. The power generation unit according to claim 30, wherein the electrical connection means (9-12) supplies a voltage of at least 10 kV.

34. The power generation unit according to claim 33, wherein the electrical connection means (9-12) includes a capacitor (10) connected to ground.

35. The power generation unit according to claim 30, wherein a stator winding of the generator includes a cable.

36. The power generation unit according to claim 35, wherein the cable includes a central core (31) of conducting material surrounded by an insulation system including an inner (32) and an outer (34) semiconducting layer and an intermediate layer (33) of solid insulating material.

37. The power generation unit according to claim 30, wherein the electrical connecting means includes a supervising system (14) for measuring, controlling and/or governing the operation of the power generation unit.

38. The power generation unit according to claim 37, wherein the supervising system includes measuring means (15) for measuring the current, the voltage and/or the load angle.

39. The power generation unit according to claim 37, wherein the supervising system includes synchronizing means (16) for synchronizing the voltage of the power generation unit to the voltage of the electrical network.

40. The power generation unit according to claim 37, wherein the supervising system includes a protection relay (17).

41. The power generation unit according to claim 37, wherein the supervising system includes means (18) for controlling the active and reactive power.

42. The power generation unit according to claim 37, wherein the supervising system includes means (19) for measuring the amount of delivered energy.

43. The power generation unit according to claim 37, wherein the supervising system includes means (20) for electrically braking the turbine.

44. The power generation unit according to claim 37, wherein the supervising system includes means (21) for electrically locking the turbine.

45. The power generation unit according to claim 37, wherein the supervising system includes means (22) for controlling starting-up of the turbine.

46. The power generation unit according to claim 37, wherein the supervising system includes a micro-processor (23) having means (24) for receiving input signals representing data from the supervising system, means (25) for processing said received signals and means (26) for providing output signals representing operation commands to the supervising system.

47. The power generation unit according to claim 30, wherein the electrical control means includes a wye-delta-transformer (12).

48. The power generation unit according to claim 30, wherein the electrical control means includes controllable power semiconductors, such as IGBT:s, GTO:s and/or thyristors.

49. The power generation unit according to claim 30, wherein the electrical control means includes a 6-pulse or a 12-pulse inverter (11).

50. A power plant comprising a plurality of power generation units according to claim 30 which are connected to the same DC-voltage-level.

51. A method for generating electric energy in which a turbine is exposed to a flowing fluid of varying velocity, the turbine drives a generator and the generator is connected to an electric network characterized by substantially maintaining the rpm of said turbine by providing the rotor of the generator with permanent magnets, operating the generator as a synchronous generator and at a low load angle that is smaller than 12°, providing a diode rectifier for supplying DC-voltage, regulating the DC-voltage-level and thereby electrically controlling the rotational spread of the turbine to be substantially constant, the DC-voltage-level being controlled by an inverter with inverter-control means, by a transformer with ratio-control means and/or by changing the number of active winding turns in the generator.
